(19) United States
(12) Patent Application Publication
(10) Pub. No.: US 2022/0402570 A1
(43) Pub. Date: Dec. 22, 2022

(54) HEADSET WITH DAMPING BEARING ASSEMBLY

(71) Applicant: Cane Creek Cycling Components, Inc., Fletcher, NC (US)

(72) Inventors: Eric Smith, Asheville, NC (US); Jeff LaForge, Asheville, NC (US)

(21) Appl. No.: 17/354,694

(22) Filed: Jun. 22, 2021

(51) Int. Cl. B62K 19/32; B62K 21/06

(52) U.S. Cl. CPC B62K 19/32; B62K 21/06

(57) ABSTRACT

Headsets and head tube assemblies for vehicles are provided. The vehicle includes a steerer tube and a head tube. The headset is rotatably connected to the steerer tube and the head tube. The headset includes a coupling ring that has a body and a central bore defined in and extending through the body. The coupling ring is connectable to and rotatable with the steerer tube. A cup that has a body and a central bore defined in and extending through the body. The cup is connectable to and rotatable with the head tube. A bearing assembly disposed between the cup and the coupling ring. The bearing assembly has an inner race, an outer race, and a bearing member disposed between the inner race and the outer race. A damping fluid surrounds the bearing member to dampen vibrations between the steerer tube and the head tube.

### FIELD OF THE INVENTION

The present disclosure relates generally to headsets for use with vehicles such as bicycles, tricycles and motorcycles. Specifically, the present disclosure is directed to headsets which include bearing assemblies having damping features for increasing energy transmissions between the steerer tubes and head tubes of associated vehicles.

### BACKGROUND OF THE INVENTION

Headsets are generally utilized in certain types of vehicles to connect and provide a rotatable interface between a steering component and a main frame of the vehicle. For example, in a typical bicycle, an upper headset and a lower headset rotatably connect a steerer tube and a head tube. The head tube is a component of the main frame of the bicycle, and the steerer tube is a component of the bicycle fork. Headsets may be utilized in a wide variety of vehicles, including manual and motor-assisted bicycles, tricycles, motorcycles, mopeds, etc.

One issue with presently known interfaces between the steering component and main frame of such vehicles is insufficient energy transmission between such components. For example, vibrations in/of the steering components during operation of such vehicles can cause rider discomfort and/or a safety concern. It is thus generally desirable to dampen such vibrations, etc., such as by increasing energy transmission between the steering component and the main frame.

Another issue with known interfaces between the steering component and main frame of such vehicles is insufficient friction between the components, which can result in damage to the frame. For example, when the vehicle is balanced on a wall or in a stand, the current interfaces may turn too quickly (due to lack of friction) causing the vehicle to fall over and get damaged. Another common occurrence with known interfaces is collisions between the handlebar and the frame that can result in damage to the frame.

Accordingly, improved apparatus for facilitating energy transmission between the steering components and main frames of such vehicles are desired. In particular, headsets which include damping features for increasing such energy transmission would be advantageous. For example, such features will reduce vibrations experienced by the operator of the vehicle and can prevent damage to the frame of the vehicle.

### BRIEF DESCRIPTION OF THE INVENTION

Aspects and advantages of the invention will be set forth in part in the following description, or may be obvious from the description, or may be learned through practice of the invention.

In accordance with one embodiment of the present disclosure, a headset for a vehicle is provided. The vehicle includes a steerer tube and a head tube. The headset is rotatably connected to the steerer tube and the head tube. The headset includes a coupling ring that has a body and a central bore defined in and extending through the body. The coupling ring is connectable to and rotatable with the steerer tube. The headset further includes a cup that has a body and a central bore defined in and extending through the body. The cup is connectable to and rotatable with the head tube. The headset further includes a bearing assembly disposed between the cup and the coupling ring to facilitate movement between the steerer tube and the head tube. The bearing assembly has an inner race, an outer race, and a bearing member disposed between the inner race and the outer race. A damping fluid surrounds the bearing member to dampen vibrations between the steerer tube and the head tube.

In accordance with another embodiment of the present disclosure, a head tube assembly for a vehicle is provided. The vehicle includes a steerer tube. The head tube assembly rotatably connectable to the steerer tube. The head tube assembly includes a head tube. The head tube includes a body and a central passage defined in and extending through the body along a central longitudinal axis. The body extending between a first end and a second end. A first headset connected to the first end of the body and a second headset connected to the second end of the body. One of the first headset or the second headset includes a coupling ring that has a body and a central bore defined in and extending through the body. The coupling ring is connectable to and rotatable with the steerer tube. The headset further includes a cup that has a body and a central bore defined in and extending through the body. The cup is connectable to and rotatable with the head tube. The headset further includes a bearing assembly disposed between the cup and the coupling ring to facilitate movement between the steerer tube and the head tube. The bearing assembly has an inner race, an outer race, and a bearing member disposed between the inner race and the outer race. A damping fluid surrounds the bearing member to dampen vibrations between the steerer tube and the head tube.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a schematic view of a vehicle in accordance with embodiments of the present disclosure;

FIG. 2 illustrates a perspective view of a head tube assembly in accordance with embodiments of the present disclosure;

FIG. 3 is a side cross-sectional view of a portion of the head tube assembly including an upper headset, in accordance with embodiments of the present disclosure;

FIG. 4 is a side cross-sectional view of a portion of the head tube assembly including a lower headset, in accordance with embodiments of the present disclosure;

FIG. 5 illustrates an exploded view of a bearing assembly in accordance with embodiments of the present disclosure;

FIG. 6 illustrates a cross-sectional perspective view of a bearing assembly in accordance with embodiments of the present disclosure;

FIG. 7 illustrates an enlarged cross-sectional view of a bearing assembly in accordance with embodiments of the present disclosure;

FIG. 8 illustrates a cross-sectional top view of the bearing assembly in accordance with embodiments of the present disclosure; and

FIG. 9 illustrates a cross-sectional view of a head tube assembly in accordance with embodiments of the present disclosure.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components.

As used herein, the term “radially” refers to the relative direction that is substantially perpendicular to an axial centerline of a particular component, the term “axially” refers to the relative direction that is substantially parallel and/or coaxially aligned to an axial centerline of a particular component and the term “circumferentially” refers to the relative direction that extends around the axial centerline of a particular component. terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

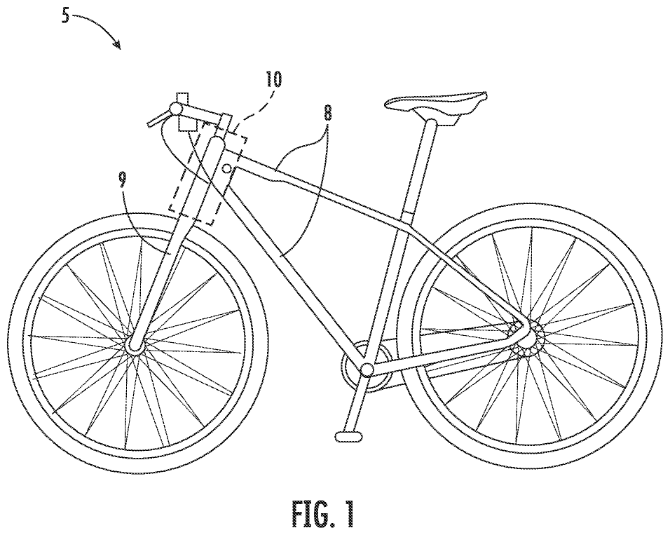

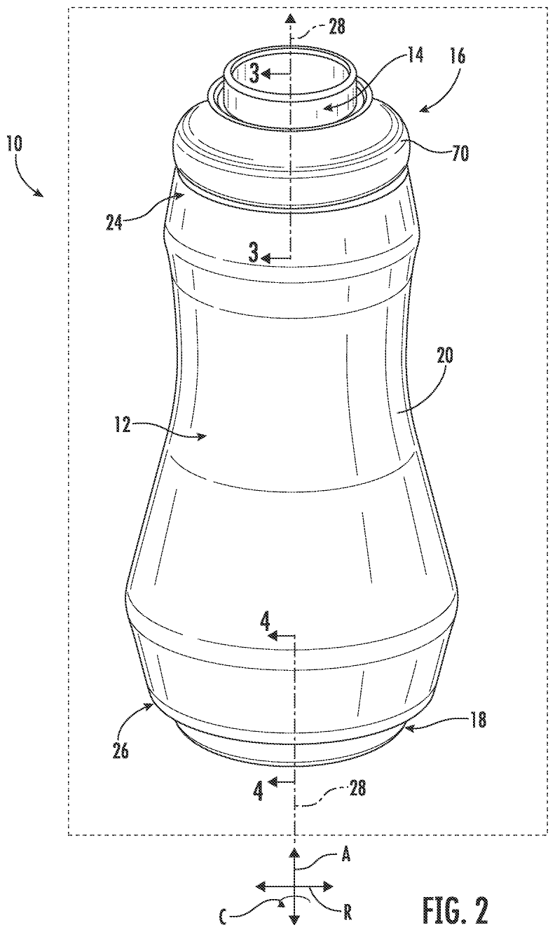

Referring now to the drawings, FIG. 1 illustrates a schematic diagram of a vehicle 5 having a head tube assembly 10. FIGS. 2 through 4 and 9 illustrate embodiments of a head tube assembly 10 are illustrated. Head tube assembly 10 includes a head tube 12 (FIG. 2) and one or more headsets, as discussed herein. As is generally understood, the head tube 12 is a component of a main frame 8 of the vehicle 5. The head tube 12 may be integral with other components of the main frame, or may be a separate component that is connected to other components of the main frame via welding, suitable mechanical fasteners, etc. In exemplary embodiments, the vehicle 5 is a bicycle, which may be manual or motor-assisted. Alternatively, the vehicle may be a tricycle, motorcycle, moped, or other suitable vehicle. In general, any suitable vehicle which requires a rotatable interface between a steering component and a main frame is within the scope and spirit of the present disclosure.

As shown in FIG. 2, the head tube assembly 10 may define a cylindrical coordinate system having an axial direction A, a radial direction R, and a circumferential direction C. The axial direction A extends along an the longitudinal axis 28. The circumferential direction C extends around the axial direction A and the longitudinal axis 28. The radial direction R is perpendicular to the axial direction A and the longitudinal axis 28.

The vehicle in which head tube assembly 10 may be utilized may further include a steerer tube 14. Steerer tube 14 may be or be part of a steering component of the vehicle. For example, as is generally understood, steerer tube 14 may be a component of a fork for a bicycle. As discussed herein, steerer tube 14 may be rotatable connectable to the head tube assembly 10, thus rotatably connecting the main frame and the steering component of the vehicle 5.

Head tube 12 includes a body 20 and a central passage 22 defined in and extending through the body 20. The passage 22 may extend through the body 20 between a first end 24 of the body 20 and a second end 26 of the body 20, and may extend along a longitudinal axis 28 defined by the body 20.

One or more headsets may be connected to the head tube 12 to form the head tube assembly 10. For example, in the embodiments shown, a first headset 16 is connected to the first end 24 of the body 20 and a second headset 18 is connected to the second end 26 of the body 20. The first headset 16 as illustrated can be referred to as an upper headset, while the second headset 18 as illustrated can be referred to as a lower headset. In exemplary embodiments, components of the headsets 16 may be press-fit into the passage 22 at the first and second ends 24, 26 to connect the headsets 16, 18 to the head tube 12.

The steerer tube 14 may generally extend through the central passage 22 and through bores defined in the headsets 16, 18. Further, as discussed herein, steerer tube 14 may be connectable (and, when assembled, connected) to components of the headsets 16, 18. Rotation of various components of the headsets 16, 18 may facilitate rotation of the steerer tube 14 relative to the head tube 12.

As discussed in detail herein, one or more headsets 16, 18 may include on or more bearing assemblies having various damping features for damping energy transmission between the steerer tube 14 and the head tube 12. Such damping features are advantageously internal to such bearing assemblies, thus providing effective connecting and damping in a single component of a head tube assembly 10 and vehicle thereof.

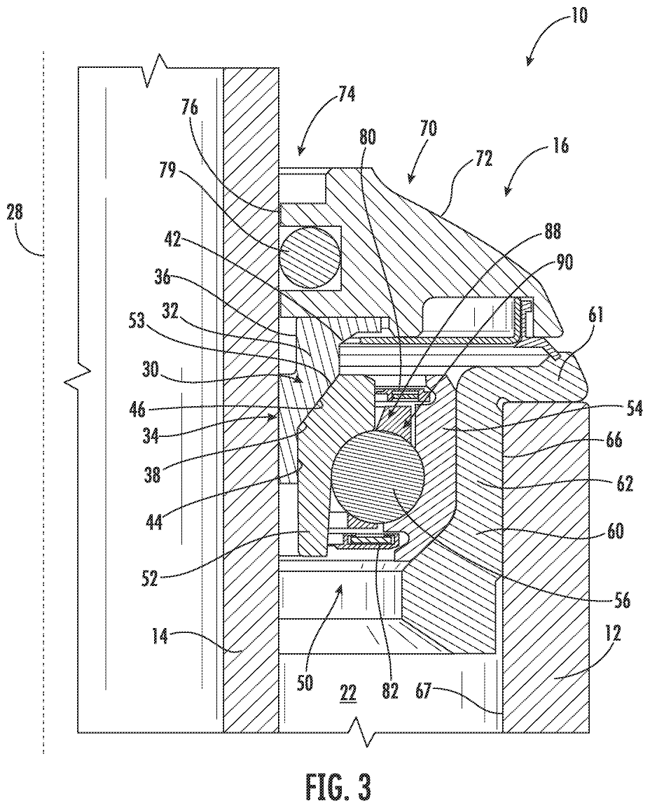

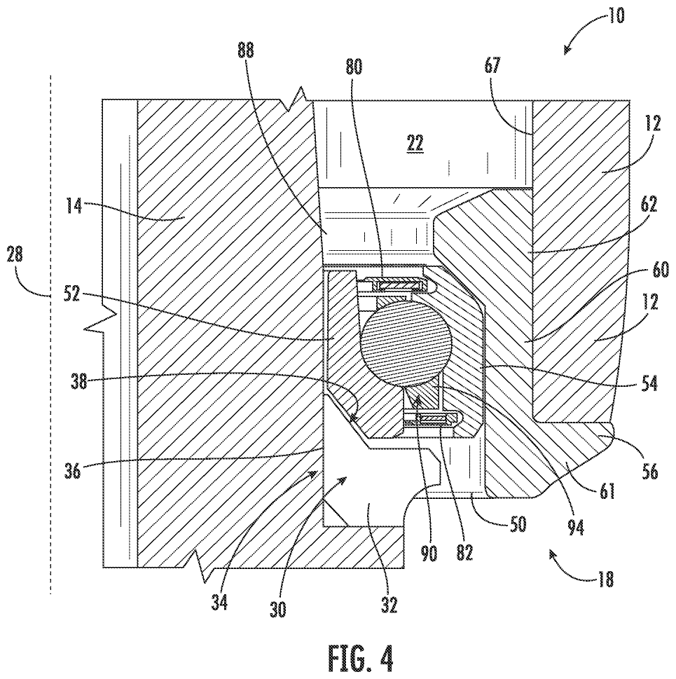

FIG. 3 illustrates a cross sectional view of a first headset 16 installed in a head tube assembly 10 from along the line 3-3 shown in FIG. 2. Similarly, FIG. 4 illustrates a cross sectional view of a second headset 18 installed in a head tube assembly 10 from along the line 4-4 shown in FIG. 2. As shown in FIGS. 3 and 4, both the headsets 16, 18 may include a coupling ring 30. Coupling ring 30 may in some embodiments be formed from a pliable material, such as a suitable elastomer, or a non-pliable material, such as aluminum or steel. Alternatively, coupling ring 30 may be formed from any suitable polymer, metal or other suitable material. Coupling ring 30 includes a body 32 and a central bore 34 which is defined in and extends through the body 32. When assembled in a head tube assembly 10, the coupling ring 30 may be generally concentric with head tube 12 with respect to the longitudinal axis 28. Coupling ring 30 may be connectable to and rotatable with the steerer tube 14. For example, steerer tube 14 may extend through the central bore 34, and an inner surface 36 of the body 32 (which defines the central bore 34) and the steerer tube 14 may be connected via a friction fit. Accordingly, when the steerer tube 14 rotates, such as about the longitudinal axis 28, the coupling ring 30 rotates with the steerer tube 14.

Coupling ring 30 may further include an outer surface 38. As illustrated, outer surface 38 may include various portions which have different diameters. Notably, each portion may be a generally annular portion of the coupling ring 30. For example, outer surface 38 may include a first portion 42 having a first outer diameter (not labeled) and a second portion 44 having a second outer diameter (not labeled). The second outer diameter may be less than or greater than the first outer diameter. Further, outer surface 38 may include an intermediate portion 46 between the first and second portions 42, 44. The intermediate portion 46 (and outer diameter (not labeled) thereof) may taper between the first portion 42 and the second portion 44. Accordingly, the intermediate portion 46 can be considered an angled portion of the outer surface 38 relative to the remainder of the outer surface 38.

Headset 16 may further include a bearing assembly 50. An inner race 52 of the bearing assembly 50 may be rotatable with the coupling ring 30. For example, intermediate portion 46 may advantageously contact inner race 52, and this contact may facilitate rotation of the coupling ring 30 (such as about longitudinal axis 28) relative to other components of the headset 16. As illustrated, bearing assembly 50 includes inner race 52, an outer race 54, and a bearing member 56 disposed between the inner race 52 and outer race 54. Inner race 52 and outer race 54 are rotatable relative to each other, and are both in contact with bearing member 56. Bearing member 56 facilitates the movement of the inner race 52 and outer race 54 by reducing friction between the two components. In exemplary embodiments, bearing member 56 may include a plurality of ball bearings. Alternatively, however, any suitable bearing component is within the scope and spirit of the present disclosure.

As illustrated, inner race 52 may include an angled surface 53. The angled surface 53 may be positioned at an angle and orientation that corresponds to the angle and orientation of the intermediate portion 46, and intermediate portion 46 may contact the angled surface 53 of the inner race 52. This contact, and the frictional forces transmitted between the intermediate portion 46 and angled surface 53, may cause the inner race 52 to rotate with the coupling ring 30. Accordingly, inner race 52 and bearing assembly 50 generally may assist and reduce the overall friction associated with rotation of the coupling ring 30.

Bearing assembly 50 may, as illustrated, be disposed within a cup 60 of the headset 16. Coupling ring 30 may additionally be partially or fully disposed within cup 60. The cup 60 may in some embodiments be formed from a rigid material, such as a suitable rigid polymer, metal or other suitable material. Cup 60 includes a body 62 and a central bore 64 which is defined in and extends through the body 62. Cup 60 may be generally concentric with the coupling ring 30 and, when assembled in a head tube assembly 10, generally concentric with head tube 12 with respect to the longitudinal axis 28. The cup 60 may be connectable to and rotatable with the head tube 12. For example, cup 60 may be press-fit into the head tube 12, such that an outer surface 66 of the cup 60 and an inner surface 67 of the head tube 12 are in contact and connected via a friction fit. Accordingly, when the head tube 12 rotates, such as about the longitudinal axis 28, the cup 60 rotates with the head tube 12. In many embodiments, the cup 60 may include a radially extending flange portion 61 that extends over an axial end of the head tube 12.

Headset 16 may further include, for example, a top cover 70, also known as a dust cover. Top cover 70 may in some embodiments be formed from a rigid material, such as a suitable rigid polymer, metal or other suitable material. Top cover 70 includes a body 72 and a central bore 74 which is defined in and extends through the body 72. Top cover 70 may be generally concentric with the coupling ring 30 and cup 60 and, when assembled in a head tube assembly 10, generally concentric with head tube 12 with respect to the longitudinal axis 28. Top cover 70 may be connectable to and rotatable with the steerer tube 14. For example, steerer tube 14 may extend through the central bore 74, and an inner surface 76 of the body 72 (which defines the central bore 74) and the steerer tube 14 may be connected via a friction fit. Accordingly, when the steerer tube 14 rotates, such as about the longitudinal axis 28, the top cover 70 rotates with the steerer tube 14.

As shown, the top cover 70 may include one or more gaskets 79, which may for example be o-rings as illustrated. The gasket 79 may be disposed between the inner surface 76 and the steerer tube 14 when the headset 16 is assembled in a head tube assembly 10, thus generally sealing the interface between the top cover 70 and the steerer tube 14.

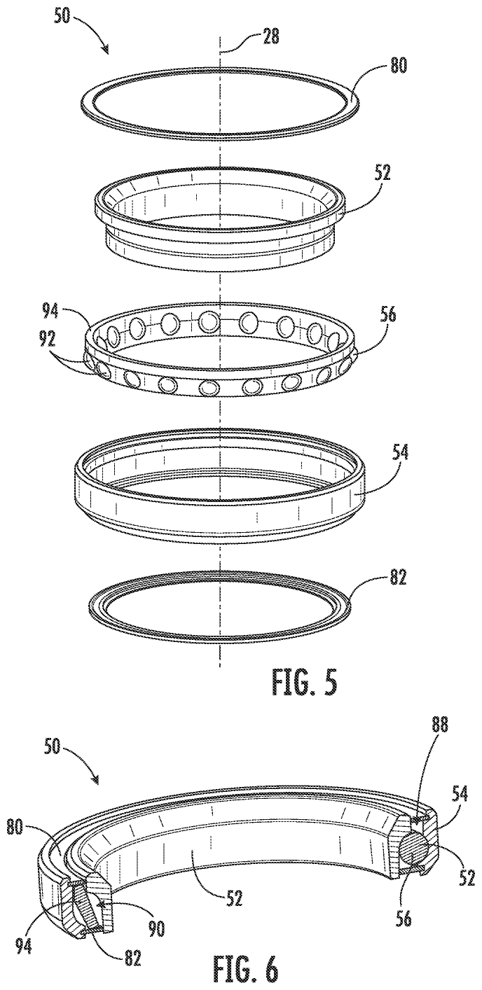

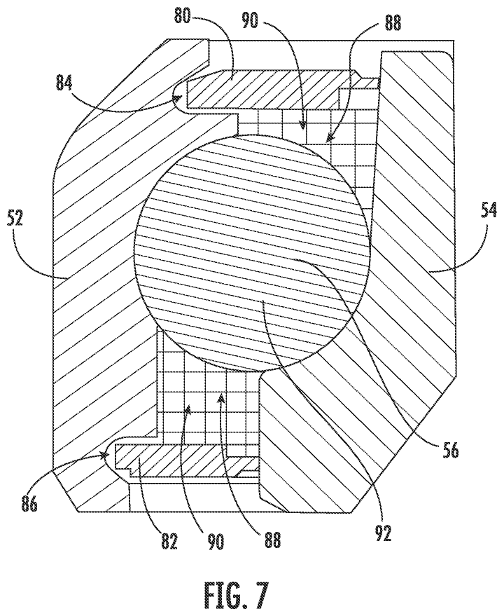

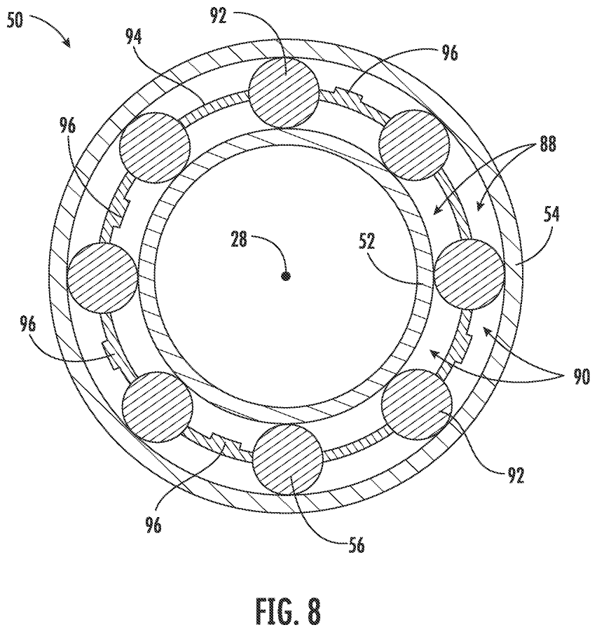

FIGS. 5 through 8 illustrate various views of a bearing assembly 50, which may be employed in one or more of the headsets 16, 18 of the head tube assembly 10 discussed above with reference to FIGS. 2 through 4. For example, FIG. 5 illustrates an exploded view of the bearing assembly 50, FIG. 6 illustrates a cross-sectional perspective view of the bearing assembly 50, FIG. 7 illustrates an enlarged cross-sectional view of the bearing assembly 50, and FIG. 8 illustrates a cross-sectional view of the bearing assembly 50 from along the longitudinal axis 28, in accordance with embodiments of the present disclosure.

As shown in FIGS. 5 through 8, the bearing assembly 50 includes an inner race 52, an outer race 54, and a bearing member 56 disposed between the inner race 52 and the outer race 54. In many embodiments, the inner race 52 may be spaced apart (e.g., radially spaced apart) from the outer race 54. The bearing member 56 be disposed between the inner race 52 and the outer race 54, such that the bearing member 56 facilitates movement between the inner race 52 and the outer race 54. In this way, the races 52, 54 may move circumferentially around the longitudinal centerline with respect to each other.

Additionally, as shown, the bearing assembly 50 may include an upper seal 80 and a lower seal 82 spaced apart from one another (e.g., axially spaced apart from one another). The upper seal 80 and the lower seal 82 may each extend from the inner race 52 to the outer race 54. For example, as shown best in FIG. 7, the inner race 52 may define an upper annular slot 84, into which the upper seal 80 may extend to couple the upper seal 80 to the inner race 52. Similarly, the inner race 52 may define a lower annular slot 86, into which the lower seal 82 may extend to couple the lower seal 82 to the inner race 52. Both the upper seal 80 and the lower seal 82 may extend outwardly (e.g., radially outwardly with respect to the longitudinal axis 28) from the respective slot 84 and 86 to an inner surface of the outer race 54, such that both the upper seal 80 and the lower seal 82 are in sliding contact with the outer race 54.

Many of the components of the bearing assembly 50 may be annular components, e.g., the inner race 52, the outer race 54, the upper seal 80, and the lower seal 82, and others, may be annular components, such that they each extend circumferentially (or 360 degrees) around the longitudinal axis 28. In this way, the bearing assembly 50, when installed in a head tube assembly 10, may facilitate circumferential movement between the steerer tube 14 and the head tube 12.

In many embodiments, an interior 88 of the bearing assembly 50 may be collectively defined by the inner race 52, the outer race 54, the upper seal 80, and the lower seal 82. In this way, the inner race 52, the outer race 54, the upper seal 80, and the lower seal 82 may collectively define the boundaries of the interior 88 of the bearing assembly 50. In many embodiments, the bearing member 56 may be disposed in the interior 88, such that the bearing member 56 is collectively surrounded by the inner race 52, the outer race 54, the upper seal 80, and the lower seal 82. In this way, the bearing member 56 may be housed within the interior 88 of the bearing assembly.

In exemplary embodiments, as illustrated by the grid pattern surrounding the bearing member 56 in FIG. 7, a damping fluid 90 (such as a damping liquid or grease shown by the grid pattern in FIG. 7) may surround the bearing member 56 to dampen (and/or lubricate) vibrations between the steerer tube 14 and the head tube 12 (e.g., during operation of the vehicle 5). For example, the damping fluid 90 may be a highly viscous grease (e.g., an oil or lubricant having high fluid friction) that resists movement or vibrations. For example, a fluids viscosity value is a measure of that fluids resistance to flow (e.g., it describes the internal friction of the moving fluid), such that a fluid having a high viscosity value (e.g., the damping fluid 90) may resist movement within the bearing assembly 50. This advantageously makes the bearing assembly 50 more stiff, thereby increasing the bearing assembly's 50 resistivity to operational vibrations of the vehicle 5, which results in a smoother operating experience of the vehicle 5.

In particular, the interior 88 of the bearing assembly 50 may be filled with the damping fluid 90 such that the bearing member 56 is surrounded by the damping fluid 90 (as shown by the grid pattern in FIG. 7, which represents the damping fluid 90). In this way, the bearing member 56 may be in frictional communication through the fluid damping fluid 90, which increases the overall stiffness of the headset 16, 18 and the head tube assembly 10. For example, when one or more bearing assemblies 50 having the damping fluid 90 are employed within the head tube assembly 10, the steerer tube 14 and the head tube 12 may be advantageously more resistive to micro-movements or vibrations caused during operation of the vehicle 5. For example, when the steerer tube 14 rotates relative to the head tube 12 (FIGS. 3 and 4), the corresponding one of the races 52, 54 rotates relative to the other. This rotation causes the bearing member 56 rotate (or move) through the highly viscous damping fluid 90, which favorably dampens or reduces any micro-movements or vibrations experienced by the operator of the vehicle 5.

In particular embodiments, the damping fluid 90 may have a kinematic viscosity value of greater than 150 cm²/s. In some embodiments, the damping fluid 90 may have a kinematic viscosity value of between about 140 cm²/s and about 220 cm²/s. In other embodiments, the damping fluid 90 may have a kinematic viscosity value of between about 150 cm²/s and about 210 cm²/s. in many embodiments, the damping fluid 90 may have a kinematic viscosity value of between about 160 cm²/s and about 200 cm²/s. In particular embodiments, the damping fluid 90 may have a kinematic viscosity value of between about 170 cm²/s and about 190 cm²/s. The kinematic viscosity values identified for the damping fluid 90 above may be measured at atmospheric temperature (e.g., between about 0° C. and about 35° C.), w

By employing a bearing assembly 50 having a damping fluid 90 with the kinematic viscosity values identified in the ranges above, the overall stiffness of the bearing assembly 50 may advantageously increase, which makes the headsets 16, 18 and the head tube assembly 10, in which the bearing assembly 50 is installed, more resistive to micro-movements or vibrations.

In exemplary embodiments, the damping fluid 90 may be a dimethyl silicone grease, such as but not limited to a fluorocarbon gel (such as Fluorocarbon Gel 880 and/or Fluorocarbon Gel 868). Such dimethyl silicone grease may include one or more rust inhibitors, such that the damping fluid 90 advantageously does not produce rust in various other components it contacts in the bearing assembly 50.

In particular embodiments, as shown in FIGS. 5-8, the bearing member 56 may be a plurality of circumferentially spaced ball bearings 92 disposed in a retainer 94. The retainer 94 may be an annular member that defines a plurality of openings in which each ball bearing 92 is rotatably held in place, such that the ball bearings 92 may rotate in any direction when positioned in the retainer 94. This allows the inner race 52 and the outer race 54 may rotate relative to one another via the rotation of the ball bearings 92 in the retainer 94. As shown, the ball bearings 92 and the retainer 94 may be disposed in the interior 88 of the bearing assembly 50, such that they are surrounded by the damping fluid 90.

In some embodiments, as shown in FIG. 8, the retainer may include one or more protrusions 96 (e.g., radially extending protrusions with respect to the longitudinal axis 28). The protrusions 96 may extend either or both radially inwardly or radially outwardly from the retainer 94. The protrusions may be in frictional communication with the damping fluid 90 in the interior 88. For example, the protrusions may provide additional surface area in the form of a flow blockage, which increases the damping fluid 90 resistivity to movement in the interior, thereby advantageously increasing the stiffness of the bearing assembly 50.

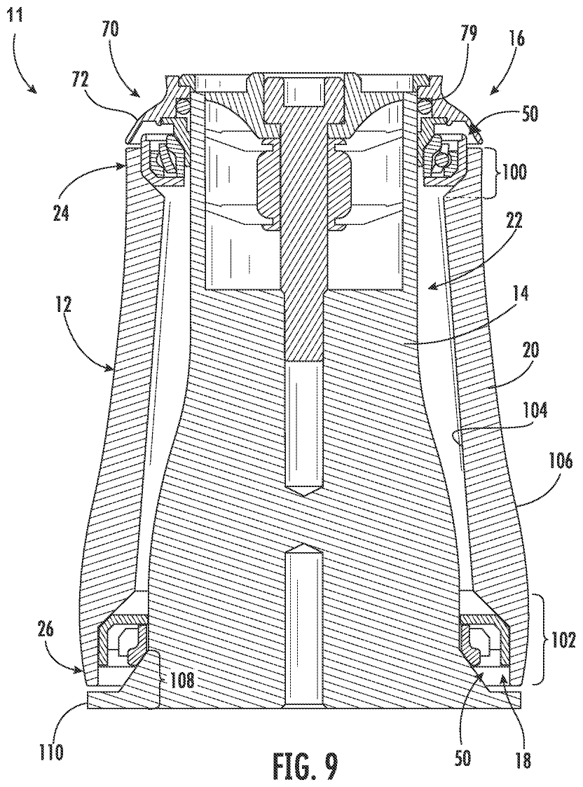

Referring now to FIG. 9, a cross-sectional view of an alternative embodiment of a head tube assembly 11 is illustrated. As shown, the head tube assembly 11 may include a head tube 12 and a steerer tube 14 rotatably coupled to the head tube via one or more headsets 16, 18. For example, the head tube assembly 11 may include a first headset 16 connected to the first end 24 of the body 20 and a second headset 18 connected to the second end 26 of the body 20. The first headset 16 as illustrated can be referred to as an upper headset, while the second headset 18 as illustrated can be referred to as a lower headset.

As shown in FIG. 9, the head tube 12 of the head tube assembly 11 may define an upper cup portion 100 and a lower cup portion 102. For example, the geometry of the cup 60 shown in the embodiments of FIGS. 3 and 4 may be integrated directly into the head tube 12. Particularly, the head tube 12 may define an interior surface 104 and an exterior surface 106 such that a thickness of the head tube 12 is defined between the surfaces 104, 106. At the cup portions 100, 102, the interior surface 104 may diverge radially outwardly (e.g., towards the exterior surface 106), such that the thickness of the head tube 12 is gradually reduced. In this way, the cup portions 100 and 102 advantageously allow the headsets 16, 18 to rotatably couple the head tube 12 to the steerer tube 14.

Additionally, as shown in FIG. 9, the steerer tube 14 may define a fork crown race portion 108 that includes a flange 110. The fork crown race portion 108 may couple the steerer tube 14 to the fork 9 (FIG. 1), e.g., via the flange 110. In the embodiment shown in FIG. 9, the fork crown race portion 108 is integral to the steerer tube, thereby not requiring any additional hardware or components to facilitate coupling the head tube assembly 11 to the fork.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A headset for a vehicle, the vehicle comprising a steerer tube and a head tube, the headset rotatably connecting the steerer tube and the head tube, the headset comprising:
a coupling ring comprising a body and a central bore defined in and extending through the body, the coupling ring connectable to and rotatable with the steerer tube;
a cup comprising a body and a central bore defined in and extending through the body, the cup connectable to and rotatable with the head tube;
a bearing assembly disposed between the cup and the coupling ring to facilitate movement between the steerer tube and the head tube, the bearing assembly comprising an inner race, an outer race, and a bearing member disposed between the inner race and the outer race, and wherein a damping fluid surrounds the bearing member to dampen vibrations between the steerer tube and the head tube.

2. The headset of claim 1, wherein the damping fluid has a kinematic viscosity value of greater than 150 cm²/s.

3. The headset of claim 1, wherein the damping fluid is a dimethyl silicone grease.

4. The headset of claim 1, wherein the bearing assembly further comprises a upper seal and a lower seal.

5. The headset of claim 4, wherein an interior of the bearing assembly is collectively defined by the inner race, the outer race, the upper seal, and the lower seal.

6. The headset of claim 5, wherein the bearing member is disposed in the interior of the bearing assembly.

7. The headset of claim 6, wherein the interior of the bearing assembly is filled with the damping fluid such that the bearing member is surrounded by the damping fluid.

8. The headset of claim 1, wherein the bearing member comprises a retainer and a plurality of ball bearings circumferentially spaced apart and disposed in the retainer.

9. The headset of claim 8, wherein the retainer comprises a plurality of protrusions.

10. The headset of claim 1, wherein the inner race is rotatable with the coupling ring, and wherein the outer race is rotatable with the cup.

11. A head tube assembly for a vehicle, the vehicle comprising a steerer tube, the head tube assembly rotatably connectable to the steerer tube, the head tube assembly comprising:
a head tube, the head tube comprising a body and a central passage defined in and extending through the body along a central longitudinal axis, the body extending between a first end and a second end; and
a first headset connected to the first end of the body and a second headset connected to the second end of the body, wherein one of the first headset or the second headset comprises:
a coupling ring comprising a body and a central bore defined in and extending through the body, the coupling ring connectable to and rotatable with the steerer tube;
a cup comprising a body and a central bore defined in and extending through the body, the cup connectable to and rotatable with the head tube; and
a bearing assembly disposed between the cup and the coupling ring to facilitate movement between the steerer tube and the head tube, the bearing assembly comprising an inner race, an outer race, and a bearing member disposed between the inner race and the outer race, and wherein a damping fluid surrounds the bearing member to dampen vibrations between the steerer tube and the head tube.

12. The head tube assembly of claim 11, wherein the damping fluid has a kinematic viscosity value of greater than 150 cm²/s.

13. The head tube assembly of claim 11, wherein the damping fluid is a dimethyl silicone grease.

14. The head tube assembly of claim 11, wherein the bearing assembly further comprises a upper seal and a lower seal.

15. The head tube assembly of claim 14, wherein an interior of the bearing assembly is collectively defined by the inner race, the outer race, the upper seal, and the lower seal.

16. The head tube assembly of claim 15, wherein the bearing member is disposed in the interior of the bearing assembly.

17. The head tube assembly of claim 16, wherein the interior of the bearing assembly is filled with the damping fluid such that the bearing member is surrounded by the damping fluid.

18. The head tube assembly of claim 11, wherein the bearing member comprises a retainer and a plurality of ball bearings circumferentially spaced apart and disposed in the retainer.

19. The head tube assembly of claim 18, wherein the retainer comprises a plurality of protrusions.

20. The head tube assembly of claim 11, wherein the inner race is rotatable with the coupling ring, and wherein the outer race is rotatable with the cup.
